(19) United States
(12) Patent Application Publication
(10) Pub. No.: US 2004/0069573 A1
(43) Pub. Date: Apr. 15, 2004

(54) Capacitive sensor for detecting the thickness or application of an automobile brake pad

(75) Inventor: William T. Anderson, Chanhassen, MN (US)

Correspondence Address: Christopher R. Christenson, Westman, Champlin & Kelly, Suite 1600, 900 Second Avenue South, Minneapolis, MN, 55402-3319, US

(73) Assignee: Rosemount Inc., Eden Prairie, MN

(21) Appl. No.: 10/631,905

(22) Filed: Jul. 31, 2003

Related U.S. Application Data
(60) Provisional application No. 60/400,368, filed on Jul. 31, 2002.

(51) Int. Cl. F16D 66/02

(52) U.S. Cl. 188/1.11 L; 340/454

(57) ABSTRACT

A capacitive sensor for sensing the thickness of an automobile brake pad is provided. The sensing capacitor includes a pair of parallel plates that are arranged such that brake pad wear reduces the size of one or both of the pads. The reduced size of the plate(s) is detectable as a change in capacitance between the plates. In on aspect a reference capacitor is also placed within the brake pad. The reference capacitor includes a pair of plates that do not change size during wear of the brake pad. The capacitance of the sensing capacitor can be compared to the capacitance of the reference capacitor for a more accurate indication of pad wear.

### CROSS REFERENCE TO RELATED APPLICATION

This application claims priority to pending U.S. Provisional Application Serial No. 60/400,368, filed Jul. 31, 2003 entitled CAPACITIVE SENSOR FOR DETECTING THE THICKNESS OR APPLICATION OF AN AUTOMOBILE BRAKE PAD.

### BACKGROUND OF THE INVENTION

Safety is a primary concern for automobile manufacturers. A considerable amount of time, effort, and cost is incurred in order to improve the safety of vehicles. Airbags, seatbelts, anti-lock brakes, and crumple-zones are some of the most notable safety features that have been developed in the last forty years. However, if a car is to have any chance of being safe, it is absolutely necessary that the vehicle be able to come to a stop. Of course, this requires that the car have an adequate braking system.

One component of the braking system is the brake shoes. The principle behind the brake pad is very simple—it provides a source of friction to force the wheels to come to a stop. However, if the brake pads have worn down excessively, it is possible that the brake pad will not work correctly, possibly resulting in expensive damage to the rotors. It is also possible that the pads may fail to bring the car to a stop.

There are two common methods used to indicate brake wear. The first method involves using a different material than the normal pad material. This different material is placed at the backside of the brake pad (away from the rotor). Eventually, after the pad is worn down, this different material begins to come in contact with the brake rotor. This material is designed to create a loud squeaking sound, to indicate to the driver that the brake pads need to be replaced. Unfortunately, this relies on the ability of the driver to hear the sound. Some drivers may fail to hear this auditory warning, or fail to understand the significance of it. Eventually, this material will wear down as well, at which point the rotor will become damaged and require expensive repairs. Of course, no product can make a driver responsible, nor can a product teach a driver how to properly maintain his/her vehicle; yet it is indeed reasonable to expect that if a driver knows that his/her brakes are bad, then he/she will get them fixed.

Since not all drivers pay attention to the sounds made by the above method, another method has been developed. This method involves using a sensor built into the pads, such that when the brake pad is worn down to a certain point, the sensor is triggered, activating a warning light on the dash of the car. While this approach certainly reduces the chance that the problem will go unnoticed, it does not offer any other insight into the condition of the car's brakes.

Typically, it requires a visual inspection to determine the thickness of the brake pads. Further, it is difficult to know which pad has worn out. It is not uncommon for a car to experience uneven brake wear. For example, in cold climates, it is possible that the slides on one side of the car will freeze up, while the other slides continue to work correctly. This can cause uneven brake pad wear. In fact, it is possible that all but one brake fails to work because the slides have locked up. And, unless the car is inspected, it would be difficult to know that this is occurring. Inspecting the brake pads generally requires that the mechanic remove all tires from the vehicle. Only at that point would it be discovered that uneven wear has occurred.

### SUMMARY OF THE INVENTION

A capacitive sensor for sensing the thickness of an automobile brake pad is provided. The sensing capacitor includes a pair of parallel plates that are arranged such that brake pad wear reduces the size of one or both of the pads. The reduced size of the plate(s) is detectable as a change in capacitance between the plates. In one aspect a reference capacitor is also placed within the brake pad. The reference capacitor includes a pair of plates that do not change size during wear of the brake pad. The capacitance of the sensing capacitor can be compared to the capacitance of the reference capacitor for a more accurate indication of pad wear.

### BRIEF DESCRIPTION OF THE DRAWINGS

FIG. 1 is a perspective view of an electronic brake pad sensor in accordance with an embodiment of the present invention.

FIG. 2 is a diagrammatic view of an embodiment of the present invention preferably usable with drum brakes.

FIG. 3 is a diagrammatic view of an embodiment of the present invention preferably usable with disc brakes.

### DETAILED DESCRIPTION OF THE PREFERRED EMBODIMENTS

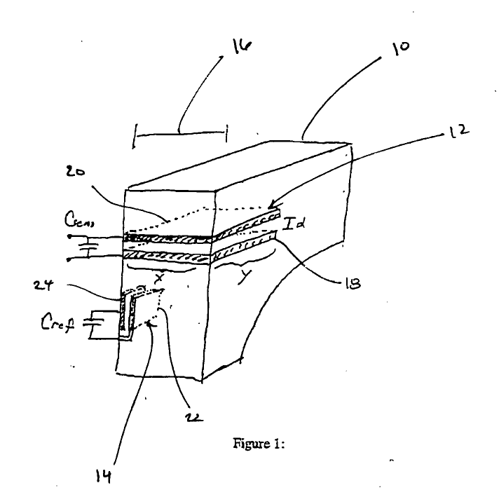

FIG. 1 is a diagrammatic view of an embodiment of the present invention where a simple capacitor is used to measure the thickness of brake shoes. For embodiments of the present invention it is preferred that the pad material itself be substantially non-conductive and have a suitable dielectric constant. Brake pad 10 is shown having a pair of parallel plate capacitors 12 and 14 disposed therein. In the embodiment illustrated in FIG. 1, brake pad wear is in a direction that reduces the pad thickness 16. Plates 18, 20 of capacitor 12 are preferably arranged to be parallel to one another, and positioned in such a way that brake pad wear will affect the size of one or preferably both of plates 18, 20.

Brake pad 10 also includes capacitor 14 that is comprised of to preferably parallel plates 22, 24. Plates 22, 24 are arranged such that brake pad wear does not affect the size of either plate 22, 24. Certainly, if the brake pad is worn very excessively, even plates 22, 24 will be worn, but the vast majority of pad wear will only affect plates 18 and 20, while plates 22, 24 will remain substantially constant.

Capacitor 12 can thus be considered a sensing capacitor (C_{SENS}) and capacitor 14 can be considered a reference capacitor (C_{REF}) since its capacitance will change with C_{SENS} for non-wear related variables, but will remain constant relative to C_{SENS} with respect to pad wear. Thus the thickness of the pad will be proportional to C_{SENS}/C_{REF}. Moreover the capacitance of C_{SENS} will be proportional to the area of the parallel plates divided by the distance between the plate (which is constant). For maximum sensitivity, it is preferred that the plates of C_{SENS} be positioned to be parallel with the direction of pad wear. However, embodiments of the present invention can be practiced with any configuration where one or both of the plates of C_{SENS} simply wear differently or to a different extent than those of C_{REF}. Additionally, where factors, such as pad temperature for instance, that affect capacitance between the plates can be known, determined or derived, it is conceivable that the second capacitor CFEF need not be used.

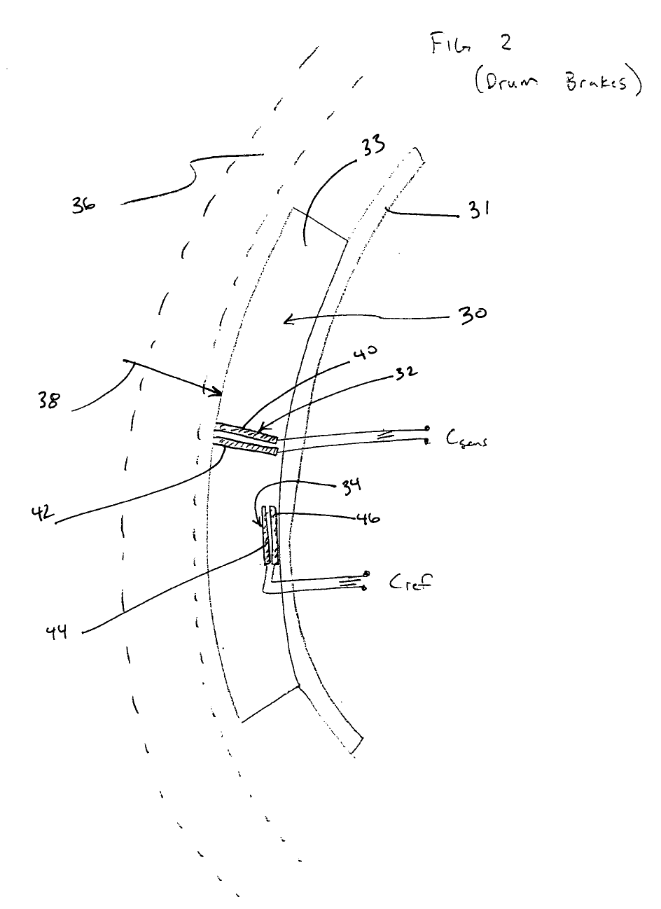

FIG. 2 is a diagrammatic view of an embodiment of the present invention preferably usable with drum brakes. Brake pad 30 includes base member 31 and pad portion 33 having C_{SENS} 32 and C_{REF} 34 therein and being configured to engage drum rotor 36 to stop the vehicle. Pad wear is in the direction of arrow 38 and such wear will affect the size of plates 40, 42 of capacitor 38 to a much greater extent than it will affect plates 44, 46 of capacitor 34.

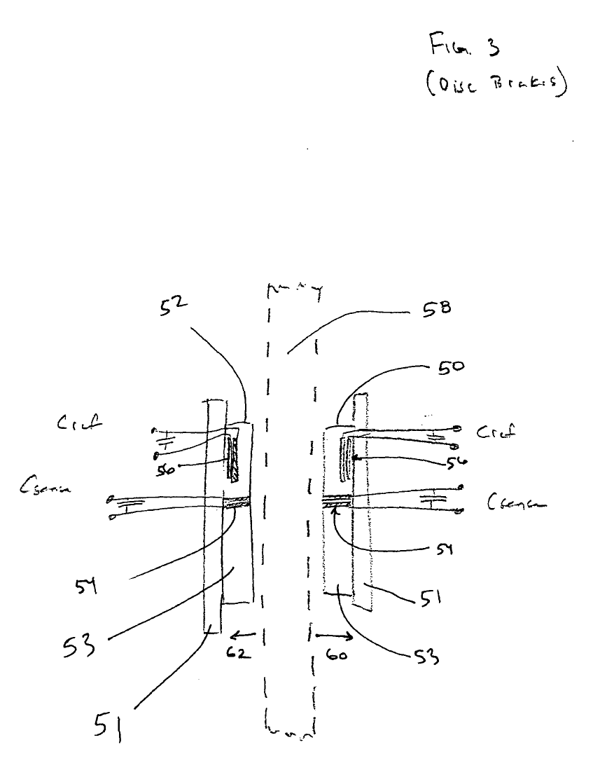

FIG. 3 is a diagrammatic view of an embodiment of the present invention preferably usable with disc brakes. Brake pads 50, 52 each preferably include base member 51 and pad portion 53 having C_{SENS} 54 and C_{REF} 56 therein and being configured to engage disc rotor 58 to stop the vehicle. Pad wear is in the direction of arrows 60, 62 and such wear will affect the size of the plates C_{SENS} capacitors 54 to a much greater extent than it will affect the plates of C_{REF} capacitors 56.

As described above, it is assumed that the brake pad material is non-conductive and has an acceptable dielectric constant. In the embodiments described above, the plates are preferably positioned so that they are parallel to each other, and such that they are perpendicular to the brake rotor. As pad wear occurs, the outer edge of the parallel plates is also worn away. This effectively reduces the area of the parallel plates, which in return linearly reduces the capacitance of the sensor. The capacitance of the embedded sensor C_{SENS} is preferably compared to a reference capacitor C_{REF}. The ratio of the two would continue to change in a linear manner, which would allow one to determine the thickness of the brake pads at any point during the pad's lifetime. Further, the thickness could be determined without having to make a visual inspection.

If the brake is applied, then the rotor and the shoes would be in contact. This would short the capacitor plates to the rotor. Thus, in order to determine the thickness of the brake pad, the end system would need to know to check the capacitor only when the brake is not being applied. However, when the brake is applied, the sensing capacitor would be shorted out. This would cause the ratio C_{SENS}/C_{REF} to equal zero. If all four brake shoes did not register a zero, then this would indicate that the brake (on the wheel not registering a zero) is perhaps not working correctly.

It is conceivable that the automobile manufacturers could collect data from these sensors to analyze the overall braking system and determine ways to further optimize the system to make it safer, more reliable, cheaper, and/or easier to maintain. If the car's computer can learn things such as the seat position for each driver, then it might be reasonable for the car to learn the driving habits of the owner and thus predictively apply the brakes based on the driver's style of driving. Further, there might be times when the car should not apply the brakes to certain wheels (perhaps the wheels that are subject to decreased traction due to ice or water on the road). These sensors could be integrated with the traction system or ABS braking system to provide the safest application of brakes, depending on the road conditions. Confirmation that a brake is either being applied or not being applied could be used in a control feedback loop for the ABS braking system. This could be especially important if the sliders are not working on one side due to freeze up.

It may even be possible to determine if the driver is “riding the brake.” Since this obviously can cause unneeded war on the brake shoes, then it may be possible to establish a system wherein the car ignores the driver's inadvertent riding of the brake. Of course, the system would have to be extremely careful in this judgment. Nonetheless, this system could make it possible.

The positioning of the reference capacitor is also important. Ideally, the reference capacitor would also be embedded within the brake pad as described above. In this manner, changes to the pad, such as temperature and moisture content, will be automatically canceled. But, the reference capacitor should be positioned such that it wears differently than the other capacitor. Preferably, the reference capacitor is parallel to the brake rotor. In this way, it would not be worn away as fast, if at all and thus ratio could remain linear.

The reference capacitor could also be used to provide the same type of sensor mentioned above. When the shoe is worn down to the point that the capacitor plate closest to the rotor is also worn away, then the ratio C_{SENS}/C_{REF} would become indeterminate, which would be a clear indication that the brake pad needed to be replaced.

There are several configurations possible in this system. It may be possible to use the brake drum as the “floating” plate for the reference capacitor. This would allow the reference capacitor to be extremely narrow.

One major advantage of these sensors is that they allow for quick brake inspections during a car's tune-up or oil change. Many car owners take their cars to service shops to have the oil changed. If the customer requests a brake inspection, it currently requires that the tires be removed. This can take better than twenty minutes to complete, in addition to the time that it takes to do the oil change. If the above sensors are in place, then the mechanic could do a very quick check by using the car's computer to determine the status of the brake pads. If the sensors indicate that they are either worn, or that there is uneven wear occurring (which would indicate another more serious problem with the brake system), then the mechanic is better informed as to how to approach the repairs. If no problem is being reported, then the mechanic does not have to waste the extra twenty minutes to do the visual inspection. Further, depending on the interface between the car's computer and the mechanic, it may be possible for the mechanic to inform the driver as to what percentage wear the brake pads have incurred. This would better help the customer to plan for future brake repairs.

Since most customers who are having their oil changed usually do not want to wait more than thirty minutes or so to have their car serviced (many use their lunch hours to have their oil changed), the customer may not be willing to wait for the brake inspection, even if it is free. This would allow the shop to speed up the process so that the customer does not have any significant waiting time. Since many shops offer free brake inspections, this would also help the shops to cut the cost of such inspections. The inspections may be free to the customer, but they are not necessarily without cost to the shop. Eventually, the customer pays this free inspection cost when they have their brakes repaired.

As mentioned before, if the pads are experiencing uneven wear, then there could be a problem somewhere else in the system. Perhaps the slides are damaged. Perhaps, the brake fluid is not making it to one brake. By having a quick way of determining which brakes are not receiving enough (or too much) wear, this may help in diagnosing the problem with the overall brake system.

If the braking system stored recent (perhaps the previous hour's worth of driving) information regarding the application of the brakes, then this information could be useful in recreating accidents. It could certainly confirm whether or not a driver applied the brakes before an accident. It could also indicate how quick their reaction by comparing information as to when the brakes were applied, how fast the car was traveling, and at what time the collision occurs. This could help insurance companies establish clear evidence of fault in an accident, or it could help a driver prove that they did all that could be expected to avoid an accident.

Although the present invention has been described with reference to preferred embodiments, workers skilled in the art will recognize that changes may be made in form and detail without departing from the spirit and scope of the invention. For example, features of the present invention are equally applicable to drum and disc brake systems. Further, although embodiments of the present invention have been described with respect to automobile brake pads, embodiments of the present invention can be practiced with respect to any application where a capacitive sensor can be effectively manufactured, or otherwise incorporated, into a material subject to wear in such a way that the capacitance changes in some regard as wear of the material occurs.

What is claimed is:

1. A brake pad for an vehicle, the brake pad comprising:
a base member;
a pad portion disposed on the base member, the pad portion being constructed from a substantially non-conductive dielectric material; and
a first pair of capacitive plates disposed in the pad portion and arranged such that wear of the pad portion changes the capacitance between the first pair of capacitive plates.

2. The brake pad of claim 1, wherein the pad portion is adapted to contact a drum rotor.

3. The brake pad of claim 1, wherein the pad portion is adapted to contact a disc rotor.

4. The brake pad of claim 1, wherein the first pair of capacitance plates are parallel to one another.

5. The brake pad of claim 1, wherein the first pair of capacitance plates are parallel to a direction of wear.

6. The brake pad of claim 5, wherein the first pair of capacitance plates are parallel to one another.

7. The brake pad of claim 1, and further comprising a second pair of capacitance plates disposed within the pad portion and arranged such that capacitance between the second pair does not change with wear of the pad portion.

8. The brake pad of claim 7, wherein wear of the pad portion is a function of the capacitance of the first pair of plates and the capacitance of the second pair of plates.

9. The brake pad of claim 8, wherein the function is the related to the quotient of the capacitance of the first pair of plates over the capacitance of the second pair of plates.

10. The brake pad of claim 1, wherein contact between at least one of the plates and a rotor is indicative of brake pad function.

11. A method of determining brake pad thickness in a vehicle, the method comprising:
measuring a capacitance between a pair of capacitive plates;
wherein the pair of capacitive plates are disposed in a portion of the brake pad subject to wear, and
wherein at least one of the pair of capacitive plates becomes smaller as the break pad wears, and in a manner that changes the capacitance between the pair of plates.

12. The method of claim 11, wherein the method is performed by an electronic control unit of the vehicle.

13. The method of claim 11, wherein the method is performed by a technician.
